(19) United States
(12) Patent Application Publication
(10) Pub. No.: US 2023/0344891 A1
(43) Pub. Date: Oct. 26, 2023

(54) SYSTEMS AND METHODS FOR QUALITY MEASUREMENT FOR VIDEOCONFERENCING

(71) Applicant: META PLATFORMS TECHNOLOGIES, LLC, Menlo Park, CA (US)

(72) Inventors: David Frenk, Seattle, WA (US); Chia-Yang Tsai, Bellevue, WA (US); Yu-Chen Sun, Bellevue, WA (US)

(21) Appl. No.: 17/718,163

(22) Filed: Apr. 11, 2022

Related U.S. Application Data
(60) Provisional application No. 63/213,578, filed on Jun. 22, 2021.

(51) Int. Cl. H04L 65/80; H04L 65/403; G10L 25/60; G10L 25/57; G06T 7/00; G06T 7/20

(52) U.S. Cl. CPC H04L 65/80; H04L 65/403; G10L 25/60; G10L 25/57; G06T 7/0002; G06T 7/20; G06T 2207/30168; G06T 2207/10016; G06T 2207/30196

(57) ABSTRACT

A computer-implemented method for quality measurement for videoconferencing may include (i) measuring the interaction levels of a plurality of video conference attendees in a group video conference, (ii) designating, based at least in part on the interaction levels, a current dominant speaker in the group video conference, (iii) calculating a video conference quality level for the current dominant speaker in the group video conference, and (iv) providing the video conference quality level for the current dominant speaker as the video conference quality level for the group video conference. Various other methods, systems, and computer-readable media are also disclosed.

### CROSS REFERENCE TO RELATED APPLICATION

This application claims the benefit of U.S. Provisional Patent Application No. 63/213,578, filed 22 Jun. 2021, the disclosure of which is incorporated herein by reference.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram of an exemplary system for quality measurement for videoconferencing.

FIG. 2 is a flow diagram of an exemplary method for quality measurement for videoconferencing.

FIG. 3 is an illustration of exemplary participation levels in a video conference.

FIG. 4 is an illustration of an exemplary video conference.

FIG. 5 is an illustration of an additional exemplary video conference.

FIG. 6 is an illustration of exemplary augmented-reality glasses that may be used in connection with embodiments of this disclosure.

FIG. 7 is an illustration of an exemplary virtual-reality headset that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

Features from any of the embodiments described herein may be used in combination with one another in accordance with the general principles described herein. These and other embodiments, features, and advantages will be more fully understood upon reading the following detailed description in conjunction with the accompanying drawings and claims.

### DETAILED DESCRIPTION OF EXEMPLARY EMBODIMENTS

In traditional video conferencing systems, group video conference quality is typically measured based on the average video quality experienced by each member of the group. For instance, a conventional video quality measurement system may determine the collective bit rate averaged over the various participants in the video conference. While this averaging approach may provide a general idea of the video quality experienced during a meeting, it fails to provide individual quality feedback, and further fails to acknowledge that, in most meetings, only a single person is usually speaking at any one time. Indeed, most traditional quality measurement solutions treat each user in the group the same, giving no deference to the different participants in the group.

The systems and methods described herein, on the other hand, may be configured to provide improvements in both video conferencing quality measurement and improvements in delivering high-quality video conferencing. Currently, as noted above, measuring the quality of real-time communications (including peer-to-peer (P2P) and group video conferences (GVCs)) may be difficult for three main reasons: 1) low latency needs to be maintained to keep end users satisfied with their GVC experience, 2) GVC video quality is constantly being adjusted throughout the connection, and 3) GVCs are encrypted to maintain privacy. The embodiments described herein may determine the quality of a GVC by determining who the current dominant speaker is and weighting the dominant speaker's statistics more heavily than other users' statistics. Alternatively, the systems described herein may use dominant speaker's video quality level as the sole measurement when determining the quality of the GVC as a whole.

In some embodiments, the systems described herein may improve the functioning of a computing device by improving the quality of a GVC on the computing device. Additionally, the systems described herein may improve the fields of videoconferencing and/or videoconferencing quality measurement by measuring GVC quality in a way that reflects the experience of users of the GVC, improving the user experience for GVC participants.

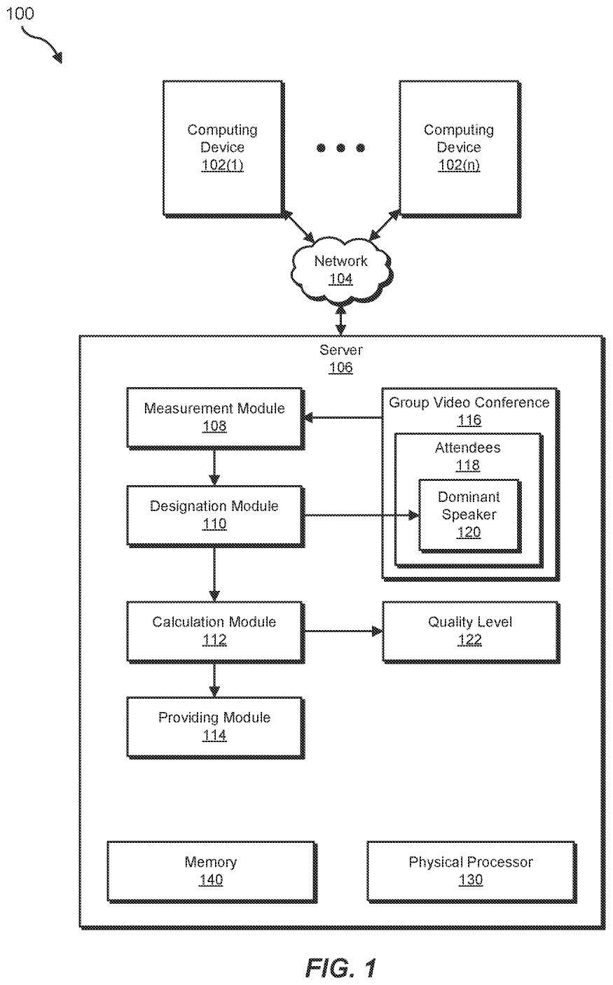

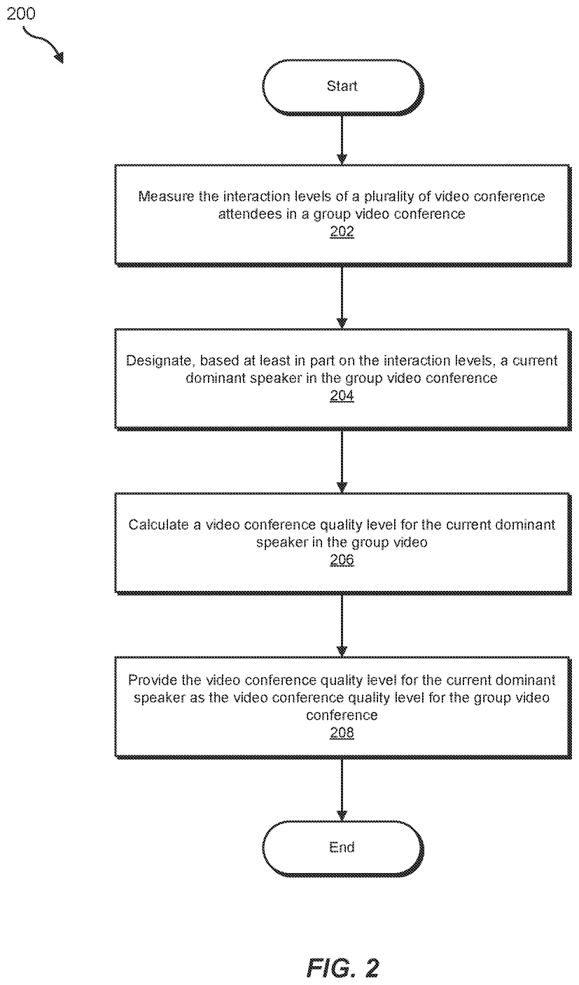

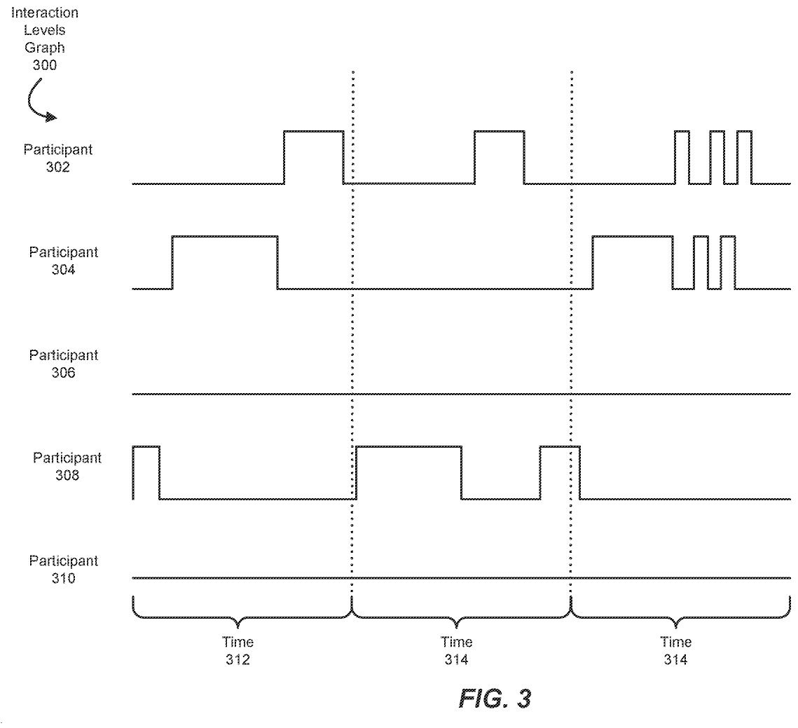

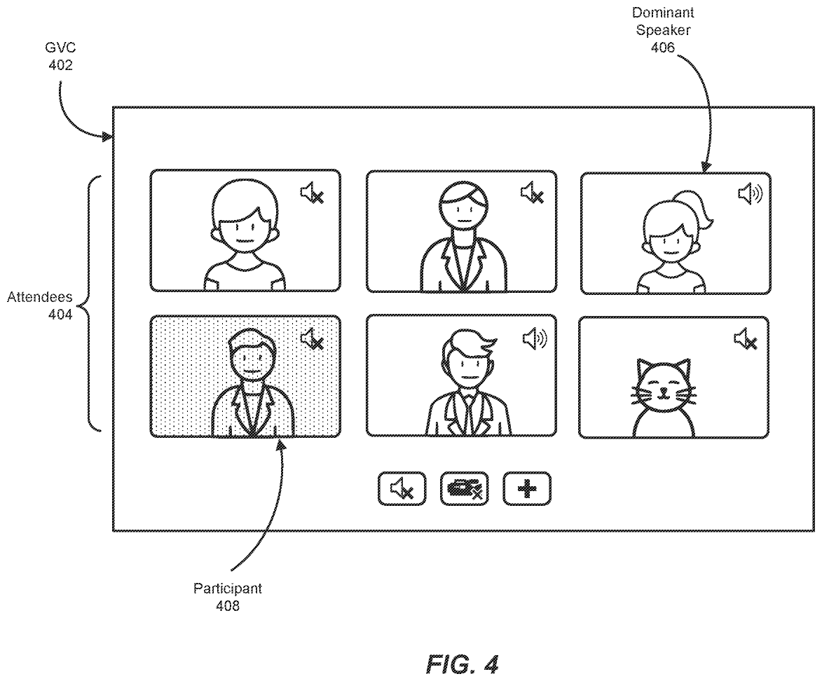

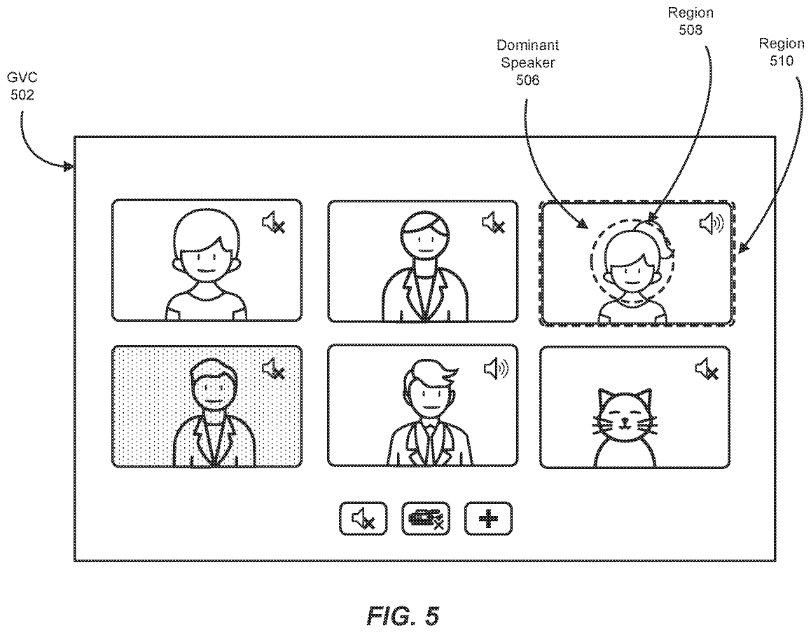

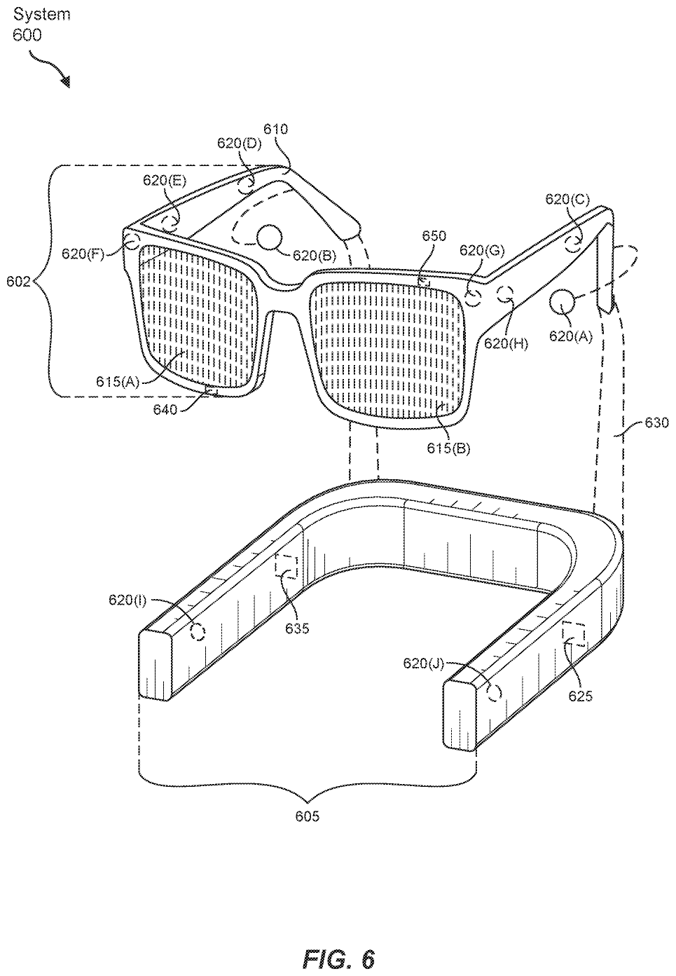

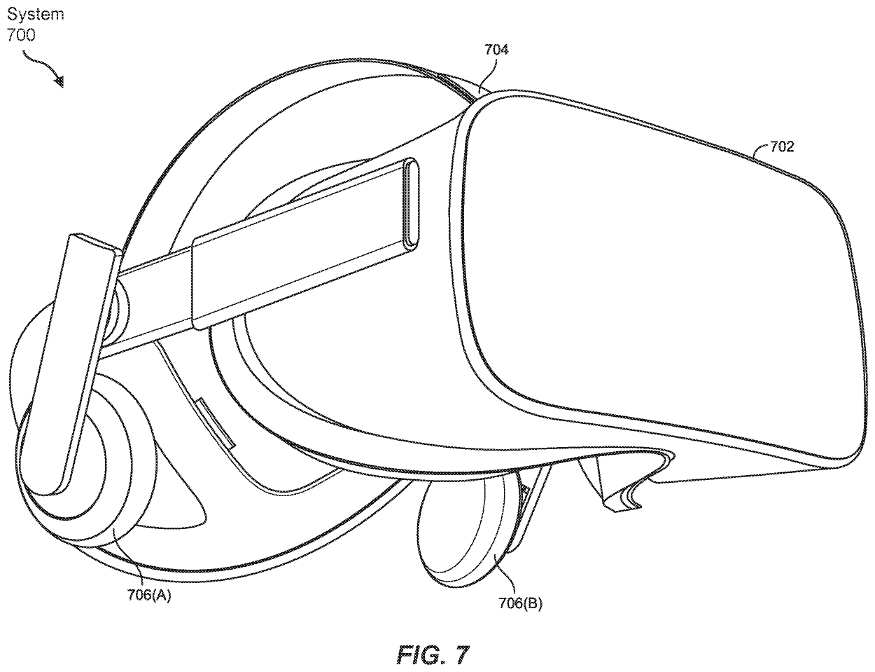

The following will provide detailed descriptions of systems and methods for measuring videoconferencing quality with reference to FIGS. 1 and 2, respectively. Detailed descriptions of exemplary levels of participation in a GVC over time will be provided in connection with FIG. 3. Detailed descriptions of exemplary GVCs and dominant speakers in GVCs will be provided in connection with FIGS. 4 and 5. In addition, detailed descriptions of exemplary augmented-reality devices that may be used in connection with embodiments of this disclosure will be provided in connection with FIGS. 6 and 7.

In some embodiments, the systems described herein may be hosted on a server that hosts video conferences. FIG. 1 is a block diagram of an exemplary system 100 for measuring GVC quality on a server. In one embodiment, and as will be described in greater detail below, a server 106 may be configured with a measurement module 108 that may measure the interaction levels of a plurality of video conference attendees 118 in a group video conference 116. In some examples, video conference attendees 118 may be operating computing devices 102(1) through 102(n) which may be communicating with server 106 via a network 104. In some embodiments, a designation module 110 may designate, based at least in part on the interaction levels, a current dominant speaker 120 in GVC 116. During or after GVC 116, a calculation module 112 may calculate a video conference quality level 122 for the current dominant speaker 120 in GVC 116. After video conference quality level 122 has been calculated, a providing module 114 may provide video conference quality level 122 as the video conference quality level for GVC 116.

Server 106 generally represents any type or form of backend computing device that may host and/or facilitate GVCs. Examples of server 106 may include, without limitation, application servers, database servers, and/or any other relevant type of server. Although illustrated as a single entity in FIG. 1, server 106 may include and/or represent a group of multiple servers that operate in conjunction with one another. Additionally or alternatively, the systems described herein may be hosted on a computing device (e.g., a personal computing device) operated by a participant in the GVC.

Computing device 102 generally represents any type or form of computing device capable of reading computer-executable instructions. For example, computing device 102 may represent a personal computing device. Additional examples of computing device 102 may include, without limitation, a laptop, a desktop, a wearable device, a smart device, an artificial reality device, a personal digital assistant (PDA), etc.

As illustrated in FIG. 1, example system 100 may also include one or more memory devices, such as memory 140. Memory 140 generally represents any type or form of volatile or non-volatile storage device or medium capable of storing data and/or computer-readable instructions. In one example, memory 140 may store, load, and/or maintain one or more of the modules illustrated in FIG. 1. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

As illustrated in FIG. 1, example system 100 may also include one or more physical processors, such as physical processor 130. Physical processor 130 generally represents any type or form of hardware-implemented processing unit capable of interpreting and/or executing computer-readable instructions. In one example, physical processor 130 may access and/or modify one or more of the modules stored in memory 140. Additionally or alternatively, physical processor 130 may execute one or more of the modules. Examples of physical processor 130 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

GVC 116 may generally refer to any multi-party audio and/or video interaction that is hosted by a central server (as opposed to P2P). In some embodiments, GVC 116 may be a videoconference with three or more attendees. In some examples, GVC 116 may be hosted by a videoconferencing platform that enables attendees to mute or unmute themselves, share content, and/or mute or unmute other attendees. Attendees may participate in GVC 116 via a variety of computing platforms, including laptops, desktops, tablets, smartphones, and/or VR devices such as headsets.

Current dominant speaker 120 generally refers to any GVC attendee designated by the systems described herein as a dominant speaker based on interaction levels. In some embodiments, the systems described herein may measure interaction levels over predetermined windows of time and designate a current dominant speaker for each window of time. For example, the systems described herein may designate a current dominant speaker based on interaction in the last five seconds, ten seconds, thirty seconds, or minute. In some examples, attendees that speak frequently or for long periods of time may be designated as dominant speakers while those that do not speak or speak only infrequently may be designated non-dominant speakers.

FIG. 2 is a flow diagram of an exemplary method 200 for quality measurement for videoconferencing. In some examples, at step 202, the systems described herein may measure interaction levels of a plurality of video conference attendees in a group video conference.

The systems described herein may measure interaction levels in a variety of ways. For example, the systems described herein may measure how much each attendee speaks, whether they are muted or not, their amount of visual movement, and/or whether they are presenting material (e.g., via screen sharing). In some embodiments, the systems described herein may measure interaction levels during discrete time intervals, such as during thirty second intervals. This time window may, of course, be shortened or lengthened for different video conferences, for different users, or for different equipment, etc. based on policies. In one embodiment, the systems described herein may measure interaction levels live as the GVC is taking place. Additionally or alternatively, the systems described herein may retroactively measure interaction levels at the end of a video conference (e.g., via a recording).

In some examples, at step 204, the systems described herein may designate, based at least in part on the interaction levels, a current dominant speaker in the group video conference.

The systems described herein may designate the current dominant speaker in a variety of ways. For example, the systems described herein may weight various factors of interaction (e.g., speech, movement, etc.) to calculate an interaction rating for each attendee and who is currently participating in the GVC may designate the attendee with the highest interaction rating as the current dominant speaker.

In some embodiments, the systems described herein may calculate interaction ratings and designate dominant speakers at intervals throughout the GVC. For example, as illustrated in FIG. 3, interaction levels graph 300 charts the interaction for participants 302, 304, 306, 308, and 310 during times 312, 314, and 316. In one example, at time 312, participant 308 may speak briefly, participant 304 may speak for a longer period of time, and the participant 302 may also speak. Because participant 304 had the highest level of interaction during time 312, the systems described herein may designate participant 304 as the current dominant speaker for time 312. By contrast, at time 314, participant 308 may speak most frequently, and so the systems described herein may designate participant 308 as the current dominant speaker for time 314. At time 316, participant 304 may once again speak most frequently, and so the systems described herein may once again designate participant 304 as the current dominant speaker.

In some examples, multiple participants may have the same or similar (e.g., within 5%, within 10%, etc.) engagement level during a time interval and the systems described herein may designate multiple current dominant speakers. For example, if two people are speaking a roughly equal amount and no one else is speaking frequently, the systems described herein may designate both speakers as the current dominant speaker.

Returning to FIG. 2, at step 206, the systems described herein may calculate a video conference quality level for the current dominant speaker in the group video conference.

The systems described herein may calculate the video conference quality level for the current dominant speaker in a variety of ways. In one embodiment, the systems described herein may calculate the bitrates of the connections between the current dominant speaker and the other participants. Additionally or alternatively, the systems described herein may calculate the image quality of frames of video being sent from the current dominant speaker (e.g., via a structural similarity image measure and/or other appropriate technique).

In some embodiments, the systems described herein may calculate a quality level for the current dominant speaker that ignores the quality level of other participants. For example, as illustrated in FIG. 4, a GVC 402 may have attendees 404 that include a dominant speaker 406 and a participant 408. In one example, the video quality level for participant 408 may be low. However, because participant 408 is not speaking, the low quality level of participant 408 may not affect the experience of the other attendees. In this example, the systems described herein may calculate a high video quality level for dominant speaker 406 regardless of the quality level of participant 408.

In some embodiments, the systems described herein may calculate an average quality level for the dominant speaker across the time that the dominant speaker is the designated dominant speaker. Additionally or alternatively, the systems described herein may calculate the lowest quality level during the time that the dominant speaker is the designated dominant speaker. For example, if the dominant speaker is typically streaming at higher quality but is blurry and distorted during a portion of the call, the systems described herein may calculate a low quality level because the lowest quality reached may have a large impact on the subjective quality as experienced by the GVC attendees even if the average quality level is high.

Returning to FIG. 2, at step 208, the systems described herein may provide the video conference quality level for the current dominant speaker as the video conference quality level for the group video conference.

The systems described herein may provide the video conference quality level in a variety of contexts. For example, the systems described herein may store the video conference quality level for analytics purposes to improve the quality of the video conferencing system. Additionally or alternatively, the systems described herein may use the video conference quality level during the GVC to improve the quality of the GVC.

In some examples, the systems described herein may calculate the video conference quality level based on a weighted average of dominant speakers throughout the group video conference. Thus, if different attendees at the group video conference are dominant speakers at different times, the video conference quality level may be a weighted average of the video quality of the various dominant speakers throughout the group video conference. In some embodiments, the systems described herein may calculate the lowest quality level for any dominant speaker and/or may calculate the quality via a histogram configured to represent the subjective user experience of conference participants.

In some embodiments, the systems described herein may calculate the quality level based on a linear combination of video quality scores from the dominant speakers and other participants. In some examples, some non-participants scores may have a weight of zero. For example, if a participant is muted during the entire GVC, the systems described herein may weight that participant's score at zero. In some examples, participants with more motion, who speak up more, and/or who are muted less during the call may have a higher weighing factor than participants who interact less. In some embodiments, the systems described herein may use other statistical and/or computational techniques such as machine learning algorithms to generate a single quality metric from any of the inputs described above. In one example, the systems described herein may use the average dominant speaker quality score, average non-dominant speaker score, and various percentile measurements as inputs to a logistic regression algorithm to generate a single quality metric with the best correlation to user-reported quality.

In some embodiments, the systems described herein may determine a video conference quality score for the GVC based on a partial screen region (e.g., a region of interest) that includes the portion of the screen (e.g., a rectangle) currently showing the dominant speaker. Depending on the bitrate (or other quality measurements) related to that portion of the screen, the systems herein may assign a video quality score for the entire video conference. The partial screen region may change as the dominant speaker changes, thereby continually prioritizing the video quality of the dominant speaker over the video quality of the other parts of the screen that depict the non-dominant speakers. For example, as illustrated in FIG. 5, a GVC 502 may have a dominant speaker 506. In one embodiment, the systems described herein may determine the quality score based on a region 510 that includes the entirety of the dominant speaker's camera display. Additionally or alternatively, the systems described herein may use any of various facial recognition techniques to identify the dominant speaker's face and may determine the quality score based on a region 508 that is centered on face or head of dominant speaker 506. Additionally or alternatively, for a GVC held via augmented reality (e.g., via devices such as those illustrated in FIGS. 6 and 7), the systems described herein may determine the quality score based on a three-dimensional region of the virtual reality environment that includes the speaker's avatar.

In some embodiments, the systems described herein may change encoding methods or encoding algorithms for different attendees. For example, systems described herein may encode the dominant speaker's portion of the screen may be encoded with a relatively high (or with the highest available) level of encoding, while the systems described herein may encode other participants (within the same screen) using a more lossy, lower-quality codec. In some embodiments, the systems described herein may use a high level of encoding for a portion of the screen that includes the dominant's speaker's entire camera display, such as region 510 in FIG. 5. Additionally or alternatively, the systems described herein may use a high level of encoding for a region that is centered on face or head of the dominant speaker such as region 508. In augmented reality embodiments, the systems described herein may use a high level of encoding for a three-dimensional region that includes the dominant speaker's avatar. In one example, the systems described herein may use AOMedia Video 1 (AV1) for the dominant speaker for improved compression efficiency while using H.264 for other participants for improved hardware support. In another example, the systems described herein may enable Context-Adaptive Binary Arithmetic Coding (CABAC) as an entropy coder for the dominant speaker while using Context-Adaptive Variable Length Coding (CAVLC) to save power consumption for others. Additionally or alternatively, the systems described herein may use software encoders for the dominant speaker for better quality while using hardware encoders for the others to conserve power.

In some examples, the encoding strategy may change over time as bandwidth improves or degrades or as different attendees become the dominant speaker. In some cases, the systems described herein may change the encoding strategy on encoding triggers including a change in dominant speaker or a change in the size of the screen portion dedicated to the dominant speaker (e.g., a switch from gallery mode to presenter mode that gives additional screen space to the dominant speaker). When the dominant speaker changes to another attendee, the encoding algorithms used may also switch, either immediately or in a smart manner after pausing for some amount of time to ensure the new dominant speaker remains the dominant speaker before switching to that person. In some embodiments, the systems described herein may switch encoding strategies when a new key frame is encoded.

In some embodiments, the systems described herein may provide the dominant speaker with higher bandwidth for packet retransmission and/or more inputs for quality measurements. For example, in conditions where data packets are being lost in the transport network, the dominant speaker may receive higher bandwidth to receive the retransmitted data packets. In some embodiments, the quality measurement for the dominant speaker may have an increased number of metrics or different metrics that allow the system to better determine video quality for the dominant speaker. In some examples, dominant speakers may also receive particularized quality measurement where the dominant speaker has at least one input that is different than inputs used for other group video conference attendees. Additionally or alternatively, the dominant speaker on the client-side video conferencing application may also affect server-side considerations including video resolution, video bitrate, video buffer, video latency, and/or the video frame rate at which the video is transmitted.

As described above, the systems and methods described herein may improve the user experience of a GVC by identifying a dominant speaker and using the video quality of the dominant speaker as a metric for the video quality of the GVC. While a GVC may have many participants, often only a single person will be speaking at a given time and the attention of all of the participants will be on that speaker. The video quality of participants who are not speaking may be largely irrelevant to the perceived video quality of the conference. By measuring the video quality of the current dominant speaker and improving the video quality of the dominant speaker (e.g. via dedicated encoding and/or transmission resources to the dominant speaker), the systems described herein may efficiently improve the perceived video quality and thus the user experience of a GVC.

Embodiments of the present disclosure may include or be implemented in conjunction with various types of artificial reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial reality systems may be designed to work without near-eye displays (NEDs). Other artificial reality systems may include an NED that also provides visibility into the real world (such as, e.g., augmented-reality system 600 in FIG. 6) or that visually immerses a user in an artificial reality (such as, e.g., virtual-reality system 700 in FIG. 7). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 6, augmented-reality system 600 may include an eyewear device 602 with a frame 610 configured to hold a left display device 615(A) and a right display device 615(B) in front of a user's eyes. Display devices 615(A) and 615(B) may act together or independently to present an image or series of images to a user. While augmented-reality system 600 includes two displays, embodiments of this disclosure may be implemented in augmented-reality systems with a single NED or more than two NEDs.

In some embodiments, augmented-reality system 600 may include one or more sensors, such as sensor 640. Sensor 640 may generate measurement signals in response to motion of augmented-reality system 600 and may be located on substantially any portion of frame 610. Sensor 640 may represent one or more of a variety of different sensing mechanisms, such as a position sensor, an inertial measurement unit (IMU), a depth camera assembly, a structured light emitter and/or detector, or any combination thereof. In some embodiments, augmented-reality system 600 may or may not include sensor 640 or may include more than one sensor. In embodiments in which sensor 640 includes an IMU, the IMU may generate calibration data based on measurement signals from sensor 640. Examples of sensor 640 may include, without limitation, accelerometers, gyroscopes, magnetometers, other suitable types of sensors that detect motion, sensors used for error correction of the IMU, or some combination thereof.

In some examples, augmented-reality system 600 may also include a microphone array with a plurality of acoustic transducers 620(A)-620(J), referred to collectively as acoustic transducers 620. Acoustic transducers 620 may represent transducers that detect air pressure variations induced by sound waves. Each acoustic transducer 620 may be configured to detect sound and convert the detected sound into an electronic format (e.g., an analog or digital format). The microphone array in FIG. 6 may include, for example, ten acoustic transducers: 620(A) and 620(B), which may be designed to be placed inside a corresponding ear of the user, acoustic transducers 620(C), 620(D), 620(E), 620(F), 620(G), and 620(H), which may be positioned at various locations on frame 610, and/or acoustic transducers 620(1) and 620(J), which may be positioned on a corresponding neckband 605.

In some embodiments, one or more of acoustic transducers 620(A)-(J) may be used as output transducers (e.g., speakers). For example, acoustic transducers 620(A) and/or 620(B) may be earbuds or any other suitable type of headphone or speaker.

The configuration of acoustic transducers 620 of the microphone array may vary. While augmented-reality system 600 is shown in FIG. 6 as having ten acoustic transducers 620, the number of acoustic transducers 620 may be greater or less than ten. In some embodiments, using higher numbers of acoustic transducers 620 may increase the amount of audio information collected and/or the sensitivity and accuracy of the audio information. In contrast, using a lower number of acoustic transducers 620 may decrease the computing power required by an associated controller 650 to process the collected audio information. In addition, the position of each acoustic transducer 620 of the microphone array may vary. For example, the position of an acoustic transducer 620 may include a defined position on the user, a defined coordinate on frame 610, an orientation associated with each acoustic transducer 620, or some combination thereof.

Acoustic transducers 620(A) and 620(B) may be positioned on different parts of the user's ear, such as behind the pinna, behind the tragus, and/or within the auricle or fossa. Or, there may be additional acoustic transducers 620 on or surrounding the ear in addition to acoustic transducers 620 inside the ear canal. Having an acoustic transducer 620 positioned next to an ear canal of a user may enable the microphone array to collect information on how sounds arrive at the ear canal. By positioning at least two of acoustic transducers 620 on either side of a user's head (e.g., as binaural microphones), augmented-reality device 600 may simulate binaural hearing and capture a 3D stereo sound field around about a user's head. In some embodiments, acoustic transducers 620(A) and 620(B) may be connected to augmented-reality system 600 via a wired connection 630, and in other embodiments acoustic transducers 620(A) and 620(B) may be connected to augmented-reality system 600 via a wireless connection (e.g., a BLUETOOTH connection). In still other embodiments, acoustic transducers 620(A) and 620(B) may not be used at all in conjunction with augmented-reality system 600.

Acoustic transducers 620 on frame 610 may be positioned in a variety of different ways, including along the length of the temples, across the bridge, above or below display devices 615(A) and 615(B), or some combination thereof. Acoustic transducers 620 may also be oriented such that the microphone array is able to detect sounds in a wide range of directions surrounding the user wearing the augmented-reality system 600. In some embodiments, an optimization process may be performed during manufacturing of augmented-reality system 600 to determine relative positioning of each acoustic transducer 620 in the microphone array.

In some examples, augmented-reality system 600 may include or be connected to an external device (e.g., a paired device), such as neckband 605. Neckband 605 generally represents any type or form of paired device. Thus, the following discussion of neckband 605 may also apply to various other paired devices, such as charging cases, smart watches, smart phones, wrist bands, other wearable devices, hand-held controllers, tablet computers, laptop computers, other external compute devices, etc.

As shown, neckband 605 may be coupled to eyewear device 602 via one or more connectors. The connectors may be wired or wireless and may include electrical and/or non-electrical (e.g., structural) components. In some cases, eyewear device 602 and neckband 605 may operate independently without any wired or wireless connection between them. While FIG. 6 illustrates the components of eyewear device 602 and neckband 605 in example locations on eyewear device 602 and neckband 605, the components may be located elsewhere and/or distributed differently on eyewear device 602 and/or neckband 605. In some embodiments, the components of eyewear device 602 and neckband 605 may be located on one or more additional peripheral devices paired with eyewear device 602, neckband 605, or some combination thereof.

Pairing external devices, such as neckband 605, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 600 may be provided by a paired device or shared between a paired device and an eyewear device, thus reducing the weight, heat profile, and form factor of the eyewear device overall while still retaining desired functionality. For example, neckband 605 may allow components that would otherwise be included on an eyewear device to be included in neckband 605 since users may tolerate a heavier weight load on their shoulders than they would tolerate on their heads. Neckband 605 may also have a larger surface area over which to diffuse and disperse heat to the ambient environment. Thus, neckband 605 may allow for greater battery and computation capacity than might otherwise have been possible on a stand-alone eyewear device. Since weight carried in neckband 605 may be less invasive to a user than weight carried in eyewear device 602, a user may tolerate wearing a lighter eyewear device and carrying or wearing the paired device for greater lengths of time than a user would tolerate wearing a heavy standalone eyewear device, thereby enabling users to more fully incorporate artificial reality environments into their day-to-day activities.

Neckband 605 may be communicatively coupled with eyewear device 602 and/or to other devices. These other devices may provide certain functions (e.g., tracking, localizing, depth mapping, processing, storage, etc.) to augmented-reality system 600. In the embodiment of FIG. 6, neckband 605 may include two acoustic transducers (e.g., 620(1) and 620(J)) that are part of the microphone array (or potentially form their own microphone subarray). Neckband 605 may also include a controller 625 and a power source 635.

Acoustic transducers 620(1) and 620(J) of neckband 605 may be configured to detect sound and convert the detected sound into an electronic format (analog or digital). In the embodiment of FIG. 6, acoustic transducers 620(1) and 620(J) may be positioned on neckband 605, thereby increasing the distance between the neckband acoustic transducers 620(1) and 620(J) and other acoustic transducers 620 positioned on eyewear device 602. In some cases, increasing the distance between acoustic transducers 620 of the microphone array may improve the accuracy of beamforming performed via the microphone array. For example, if a sound is detected by acoustic transducers 620(C) and 620(D) and the distance between acoustic transducers 620(C) and 620(D) is greater than, e.g., the distance between acoustic transducers 620(D) and 620(E), the determined source location of the detected sound may be more accurate than if the sound had been detected by acoustic transducers 620(D) and 620(E).

Controller 625 of neckband 605 may process information generated by the sensors on neckband 605 and/or augmented-reality system 600. For example, controller 625 may process information from the microphone array that describes sounds detected by the microphone array. For each detected sound, controller 625 may perform a direction-of-arrival (DOA) estimation to estimate a direction from which the detected sound arrived at the microphone array. As the microphone array detects sounds, controller 625 may populate an audio data set with the information. In embodiments in which augmented-reality system 600 includes an inertial measurement unit, controller 625 may compute all inertial and spatial calculations from the IMU located on eyewear device 602. A connector may convey information between augmented-reality system 600 and neckband 605 and between augmented-reality system 600 and controller 625. The information may be in the form of optical data, electrical data, wireless data, or any other transmittable data form. Moving the processing of information generated by augmented-reality system 600 to neckband 605 may reduce weight and heat in eyewear device 602, making it more comfortable for the user.

Power source 635 in neckband 605 may provide power to eyewear device 602 and/or to neckband 605. Power source 635 may include, without limitation, lithium ion batteries, lithium-polymer batteries, primary lithium batteries, alkaline batteries, or any other form of power storage. In some cases, power source 635 may be a wired power source. Including power source 635 on neckband 605 instead of on eyewear device 602 may help better distribute the weight and heat generated by power source 635.

As noted, some artificial reality systems may, instead of blending an artificial reality with actual reality, substantially replace one or more of a user's sensory perceptions of the real world with a virtual experience. One example of this type of system is a head-worn display system, such as virtual-reality system 700 in FIG. 7, that mostly or completely covers a user's field of view. Virtual-reality system 700 may include a front rigid body 702 and a band 704 shaped to fit around a user's head. Virtual-reality system 700 may also include output audio transducers 706(A) and 706(B). Furthermore, while not shown in FIG. 7, front rigid body 702 may include one or more electronic elements, including one or more electronic displays, one or more inertial measurement units (IMUS), one or more tracking emitters or detectors, and/or any other suitable device or system for creating an artificial-reality experience.

Artificial reality systems may include a variety of types of visual feedback mechanisms. For example, display devices in augmented-reality system 600 and/or virtual-reality system 700 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial reality systems may include a single display screen for both eyes or may provide a display screen for each eye, which may allow for additional flexibility for varifocal adjustments or for correcting a user's refractive error. Some of these artificial reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial reality systems described herein may include one or more projection systems. For example, display devices in augmented-reality system 600 and/or virtual-reality system 700 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial reality systems may also be configured with any other suitable type or form of image projection system, such as retinal projectors used in virtual retina displays.

The artificial reality systems described herein may also include various types of computer vision components and subsystems. For example, augmented-reality system 600 and/or virtual-reality system 700 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial reality system may process data from one or more of these sensors to identify a location of a user, to map the real world, to provide a user with context about real-world surroundings, and/or to perform a variety of other functions.

The artificial reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial reality devices, within other artificial reality devices, and/or in conjunction with other artificial reality devices.

By providing haptic sensations, audible content, and/or visual content, artificial reality systems may create an entire virtual experience or enhance a user's real-world experience in a variety of contexts and environments. For instance, artificial reality systems may assist or extend a user's perception, memory, or cognition within a particular environment. Some systems may enhance a user's interactions with other people in the real world or may enable more immersive interactions with other people in a virtual world. Artificial reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial reality experience in one or more of these contexts and environments and/or in other contexts and environments.

Example 1: A method for quality measurement for videoconferencing may include (i) measuring the interaction levels of a plurality of video conference attendees in a group video conference, (ii) designating, based at least in part on the interaction levels, a current dominant speaker in the group video conference, (iii) calculating a video conference quality level for the current dominant speaker in the group video conference, and (iv) providing the video conference quality level for the current dominant speaker as the video conference quality level for the group video conference.

Example 2: The computer-implemented method of example 1, where the video conference quality level includes a weighted average of dominant speakers throughout the group video conference.

Example 3: The computer-implemented method of examples 1-2, where designating the current dominant speaker includes identifying the current dominant speaker by measuring the interaction levels over a specified window of time.

Example 4: The computer-implemented method of examples 1-3, where measuring the interaction levels includes measuring audio produced by each of the plurality of video conference attendees.

Example 5: The computer-implemented method of examples 1-4, where measuring the interaction levels includes measuring movement of each of the plurality of video conference attendees.

Example 6: The computer-implemented method of examples 1-5, where calculating the video conference quality level includes calculating the video conference quality level based on a video bit rate for a partial region of a graphical user interface presenting the group video conference.

Example 7: The computer-implemented method of examples 1-6 may further include changing an encoding strategy for at least a portion of a video conference presentation screen in response to an encoding trigger.

Example 8: The computer-implemented method of examples 1-7 may further include implementing the video conference quality level for the current dominant speaker as an input parameter to determine an encoder configuration for the dominant speaker.

Example 9: The computer-implemented method of examples 1-8 may further include allocating the current dominant speaker an increased number of input metrics over other attendees to determine the encoder configuration.

Example 10: The computer-implemented method of examples 1-9 may further include allocating the current dominant speaker a higher priority of network data transmission than members of the plurality of video conference attendees who are not the current dominant speaker.

Example 11: The computer-implemented method of examples 1-10, where calculating the video conference quality level for the current dominant speaker includes utilizing at least one input that is different than inputs used to determine quality measurements for members of the plurality of video conference attendees who are not the current dominant speaker.

Example 12: A system for measuring videoconference quality may include at least one physical processor and physical memory including computer-executable instructions that, when executed by the physical processor, cause the physical processor to (i) measure the interaction levels of a plurality of video conference attendees in a group video conference, (ii) designate, based at least in part on the interaction levels, a current dominant speaker in the group video conference, (iii) calculate a video conference quality level for the current dominant speaker in the group video conference, and (iv) provide the video conference quality level for the current dominant speaker as the video conference quality level for the group video conference.

Example 13: The system of example 12, where the video conference quality level includes a weighted average of dominant speakers throughout the group video conference.

Example 14: The system of examples 12-13, where designating the current dominant speaker includes identifying the current dominant speaker by measuring the interaction levels over a specified window of time.

Example 15: The system of examples 12-14, where measuring the interaction levels includes measuring audio produced by each of the plurality of video conference attendees.

Example 16: The system of examples 12-15, where measuring the interaction levels includes measuring movement of each of the plurality of video conference attendees.

Example 17: The system of examples 12-16, where calculating a video conference quality level includes calculating the video conference quality level based on a video bit rate for a partial region of a graphical user interface presenting the group video conference.

Example 18: The system of examples 12-17, where the computer-executable instructions cause the physical processor to change an encoding strategy for at least a portion of a video conference presentation screen in response to an encoding trigger.

Example 19: The system of examples 12-18, where the computer-executable instructions cause the physical processor to implementing the video conference quality level for the current dominant speaker as an input parameter to determine an encoder configuration for the dominant speaker.

Example 20: A non-transitory computer-readable medium may include one or more computer-readable instructions that, when executed by at least one processor of a computing device, cause the computing device to (i) measure the interaction levels of a plurality of video conference attendees in a group video conference, (ii) designate, based at least in part on the interaction levels, a current dominant speaker in the group video conference, (iii) calculate a video conference quality level for the current dominant speaker in the group video conference, and (iv) provide the video conference quality level for the current dominant speaker as the video conference quality level for the group video conference.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive image data to be transformed, transform the image data into a data structure that stores user characteristic data, output a result of the transformation to select a customized interactive ice breaker widget relevant to the user, use the result of the transformation to present the widget to the user, and store the result of the transformation to create a record of the presented widget. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
measuring interaction levels of a plurality of video conference attendees in a group video conference;
designating, based at least in part on the interaction levels, a current dominant speaker in the group video conference;
calculating a video conference quality level for the current dominant speaker in the group video conference; and
providing the video conference quality level for the current dominant speaker as the video conference quality level for the group video conference.

2. The computer-implemented method of claim 1, wherein the video conference quality level comprises a weighted average of dominant speakers throughout the group video conference.

3. The computer-implemented method of claim 1, wherein designating the current dominant speaker comprises identifying the current dominant speaker by measuring the interaction levels over a specified window of time.

4. The computer-implemented method of claim 1, wherein measuring the interaction levels comprises measuring audio produced by each of the plurality of video conference attendees.

5. The computer-implemented method of claim 1, wherein measuring the interaction levels comprises measuring movement of each of the plurality of video conference attendees.

6. The computer-implemented method of claim 1, wherein calculating the video conference quality level comprises calculating the video conference quality level based on a video bit rate for a partial region of a graphical user interface presenting the group video conference.

7. The computer-implemented method of claim 1, further comprising changing an encoding strategy for at least a portion of a video conference presentation screen in response to an encoding trigger.

8. The computer-implemented method of claim 1, further comprising implementing the video conference quality level for the current dominant speaker as an input parameter to determine an encoder configuration for the dominant speaker.

9. The computer-implemented method of claim 8, further comprising allocating the current dominant speaker an increased number of input metrics over other attendees to determine the encoder configuration.

10. The computer-implemented method of claim 1, further comprising allocating the current dominant speaker a higher priority of network data transmission than members of the plurality of video conference attendees who are not the current dominant speaker.

11. The computer-implemented method of claim 1, wherein calculating the video conference quality level for the current dominant speaker comprises utilizing at least one input that is different than inputs used to determine quality measurements for members of the plurality of video conference attendees who are not the current dominant speaker.

12. A system comprising:
at least one physical processor;
physical memory comprising computer-executable instructions that, when executed by the physical processor, cause the physical processor to:
measure interaction levels of a plurality of video conference attendees in a group video conference;
designate, based at least in part on the interaction levels, a current dominant speaker in the group video conference;
calculate a video conference quality level for the current dominant speaker in the group video conference; and
provide the video conference quality level for the current dominant speaker as the video conference quality level for the group video conference.

13. The system of claim 12, wherein the video conference quality level comprises a weighted average of dominant speakers throughout the group video conference.

14. The system of claim 12, wherein designating the current dominant speaker comprises identifying the current dominant speaker by measuring the interaction levels over a specified window of time.

15. The system of claim 12, wherein measuring the interaction levels comprises measuring audio produced by each of the plurality of video conference attendees.

16. The system of claim 12, wherein measuring the interaction levels comprises measuring movement of each of the plurality of video conference attendees.

17. The system of claim 12, wherein calculating the video conference quality level comprises calculating the video conference quality level based on a video bit rate for a partial region of a graphical user interface presenting the group video conference.

18. The system of claim 12, wherein the computer-executable instructions cause the physical processor to change an encoding strategy for at least a portion of a video conference presentation screen in response to an encoding trigger.

19. The system of claim 12, wherein the computer-executable instructions cause the physical processor to implement the video conference quality level for the current dominant speaker as an input parameter to determine an encoder configuration for the dominant speaker.

20. A non-transitory computer-readable medium comprising one or more computer-readable instructions that, when executed by at least one processor of a computing device, cause the computing device to:
measure interaction levels of a plurality of video conference attendees in a group video conference;
designate, based at least in part on the interaction levels, a current dominant speaker in the group video conference;
calculate a video conference quality level for the current dominant speaker in the group video conference; and
provide the video conference quality level for the current dominant speaker as the video conference quality level for the group video conference.
